(19) United States
(12) Patent Application Publication
(10) Pub. No.: US 2017/0234153 A1
(43) Pub. Date: Aug. 17, 2017

(54) Guide Apparatus for a Turbocharger Including a Vane Lever Integrated Adjustment Ring Axial Travel Stop

(71) Applicant: BORGWARNER INC., Auburn Hills, MI (US)

(72) Inventors: Greg Williams, Arden, NC (US); Elias Morgan, Leicester, NC (US); Donald Kennedy, Asheville, NC (US)

(21) Appl. No.: 15/046,079

(22) Filed: Feb. 17, 2016

(51) Int. Cl. F01D 17/16; F02B 37/24; F01D 25/16; F02B 33/40; F01D 9/04; F01D 25/24

(52) U.S. Cl. CPC F01D 17/165; F01D 9/041; F01D 9/045; F01D 25/24; F01D 25/162; F02B 33/40; F02B 37/24; F05D 2220/40

(57) ABSTRACT

A vane lever (46) for a guide apparatus (28) of a turbocharger (10) may include a base (49). The base (49) may include a bore (48) disposed therethrough. An arm (50) may extend from the base (49) and may be receivable in an aperture (42) of an adjustment ring (40) of the guide apparatus (28). A protuberance (52) may extend from the base (49) and may be capable of limiting axial movement of the adjustment ring (40).

### FIELD OF DISCLOSURE

The present disclosure relates generally to turbochargers, and more particularly to vane levers for such turbochargers.

### BACKGROUND OF DISCLOSURE

Some turbo machines such as, but not limited to, automobiles, trucks, aircraft, locomotives, ships, and auxiliary power generators, utilize a turbocharger, which may increase the internal combustion engine efficiency and power output of such turbo machines. The turbocharger, being a turbine-driven device, may achieve this by forcing extra air into the combustion chamber of the engine. For example, exhaust gas from the engine may drive the turbine of the turbocharger to drive an impeller of the compressor, which may draw in ambient air, compress the air, and then supply this extra air to the engine. In this manner, the engine may have improved fuel economy, reduced emissions, and higher power and torque.

Some turbochargers, such as variable turbine geometry turbocharges, utilize adjustable guide vanes to regulate the gas flow leading to the turbine wheel. For example, the adjustable guide vanes may be pivotable between an upper vane ring and a lower vane ring and be mechanically engaged with an adjustment ring via a plurality of vane levers. The adjustment ring may be actuated to rotate with respect to the upper vane ring such that the rotation of the adjustment ring engages the plurality of vane levers to simultaneously pivot all of the adjustable guide vanes between a closed position and an open position.

In some designs, the adjustment ring may experience axial movement due to clearances between the adjustment ring and the plurality of vane levers. In an effort to reduce axial movement of the adjustment ring, some turbochargers have employed stationary axial stops such as, for example, standoff pins threaded into the bearing housing and machined pads on the bearing housing. While effective, the interface between the adjustment ring and such stationary axial stops may experience undesired wear as the adjustment ring may operationally rotate against the stationary axial stops.

Another example may be found in U.S. Patent Application Publication No. 2011/0171009, which discloses a variable-vane assembly having a unison ring restrained axially by axial stops. The axial stops include a cap formed at an end of a cylindrical pin section. The cap includes a first diameter that is greater than a second diameter of the cylindrical pin such that the inner edge of the unison ring engages the cylindrical pin acting as a radial stop for the unison ring. In this arrangement, the unison ring is also axially positioned between the nozzle ring and the cap such that the cap prevents excessive axial movement of the unison ring away from the nozzle ring. While effective, the unison ring may be in continuous engagement with the cylindrical pin and the cap during operational rotation of the unison ring causing frictional wear at the contact area of these components.

### SUMMARY OF DISCLOSURE

In accordance with an aspect of the disclosure, a guide apparatus for a turbocharger is provided. The guide apparatus may include a lower vane ring offset axially from an upper vane ring. A plurality of vanes may be disposed between and pivotally coupled to the upper vane ring and the lower vane ring. An adjustment ring may include a plurality of apertures and may be in mechanical association with the plurality of vanes. A plurality of vane levers may be coupled to the plurality of vanes and may be received correspondingly by the plurality of apertures. Each vane lever of the plurality of vane levers may include a protuberance facing the adjustment ring. The protuberance may be capable of limiting axial movement of the adjustment ring.

In accordance with another aspect of the disclosure, a turbocharger is provided. The turbocharger may include a turbine housing and a bearing housing disposed between the turbine housing and a compressor housing. An upper vane ring may be secured in the turbine housing and may be proximate to the bearing housing. A lower vane ring may be offset axially from the upper vane ring. A plurality of vanes may be disposed between and pivotally coupled to the upper vane ring and the lower vane ring. An adjustment ring may be in mechanical association with the plurality of vanes. A vane lever may be coupled to one vane of the plurality of vanes and may include an arm in mechanical association with the adjustment ring. The vane lever may include a protuberance facing the adjustment. The protuberance may be contactable with the adjustment ring to limit axial movement thereof.

In accordance with yet another aspect of the disclosure, a vane lever for a guide apparatus of a turbocharger may include a base. The base may include a bore disposed therethrough. An arm may extend from the base and may be receivable in an aperture of an adjustment ring of the guide apparatus. A protuberance may extend from the base and may be capable of limiting axial movement of the adjustment ring.

These and other aspects and features of the present disclosure may be better appreciated by reference to the following detailed description and accompanying drawings.

### BRIEF DESCRIPTION OF DRAWINGS

FIG. 1 is an axial cross-sectional view of an exemplary turbocharger, in accordance with an embodiment of the present disclosure;

FIG. 2 is a perspective view, with portions broken and sectioned away, of an exemplary turbocharger, in accordance with an embodiment of the present disclosure;

FIG. 3 is a perspective view, with portions broken and sectioned away, of the exemplary turbocharger of FIG. 2 viewed from the turbine housing side, in accordance with an embodiment of the present disclosure;

FIG. 4 is a plan view, with portions broken and sectioned away, of the exemplary turbocharger of FIG. 2 illustrating the plurality of vanes, the adjustment ring, the upper vane ring, and the plurality of vane levers, in accordance with an embodiment of the present disclosure;

FIG. 5 is a perspective view, with portions broken and sectioned away, exemplarily illustrating an adjustment ring, a plurality of vane levers, an upper vane ring, and a lower vane ring of a turbocharger, in accordance with an embodiment of the present disclosure; and

FIG. 6 is a perspective view of an exemplary vane lever, in accordance with an embodiment of the present disclosure.

It should be understood that the drawings are not to scale, and that the disclosed embodiments are illustrated only diagrammatically and in partial views. It should also be understood that this disclosure is not limited to the particular embodiments illustrated herein.

### DETAILED DESCRIPTION

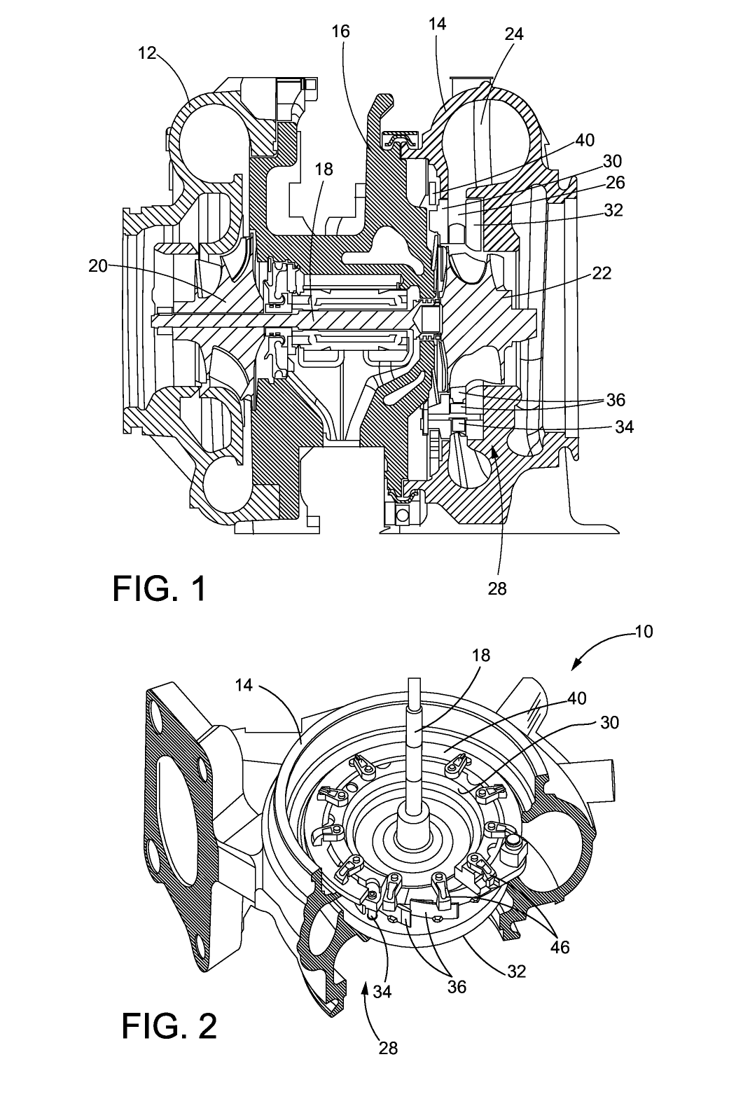

Referring now to FIG. 1, an exemplary turbocharger constructed in accordance with the present disclosure is generally referred to by reference numeral 10. The turbocharger 10 may be utilized in conjunction with an internal combustion engine of a turbo machine such as, but not limited to, an automobile, a truck, an aircraft, a locomotive, a ship, and an auxiliary power generator. The turbocharger 10 may increase the power output of such engines by extracting power from the exhaust gases of the engine to compress the air to be delivered to the air intake of the engine such that the compressed air may mix with fuel and be burned in the engine. The turbocharger 10 may include a compressor housing 12, a turbine housing 14, and a bearing housing 16 arranged between the compressor housing 12 and the turbine housing 14. The bearing housing 16 may support a rotatable shaft 18. A compressor wheel 20 may be arranged in the compressor housing 12 and may be rotatably driven via the shaft 18 by a turbine wheel 22 arranged in the turbine housing 14. The turbine housing 14 may include a volute 24, which may be a generally annual chamber that radially transitions into a throat 26.

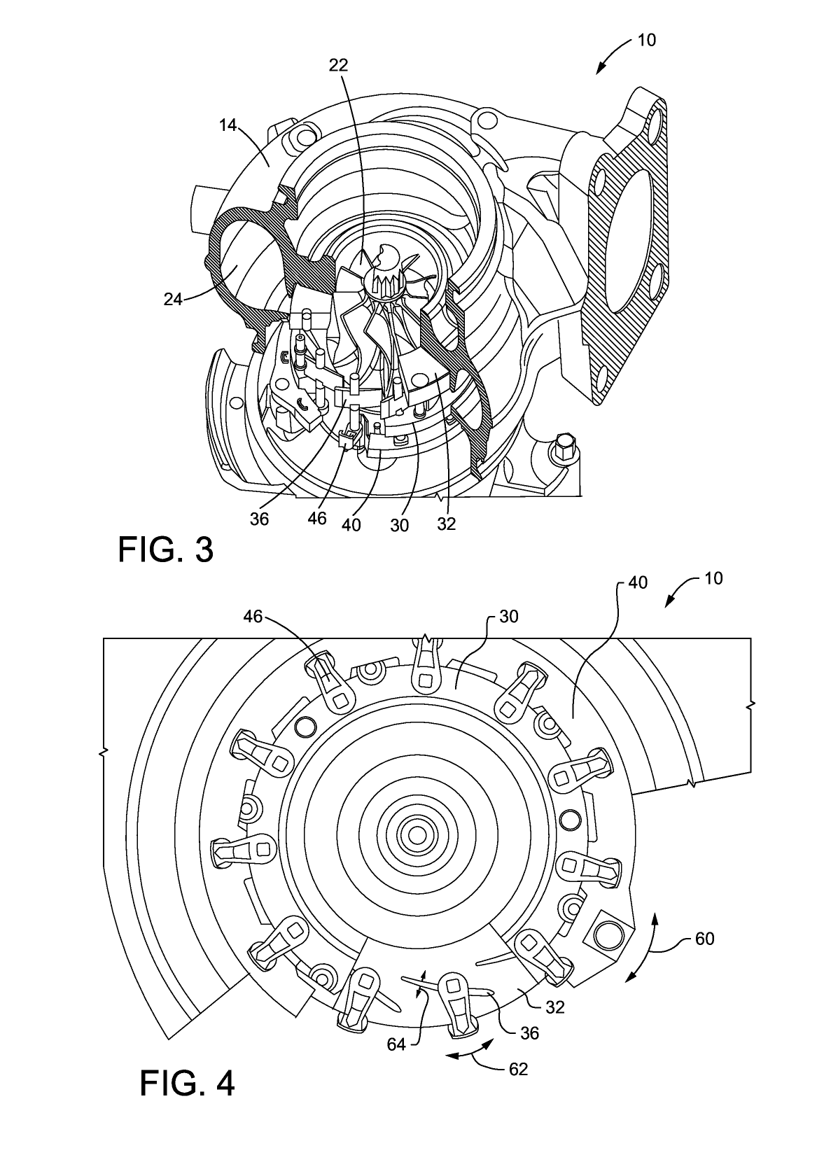

With reference to FIGS. 1-3, the turbocharger 10 may be of the variable turbine geometry (VTG) type and may include a guide apparatus 28. The guide apparatus 28 may be arranged in the turbine housing 14 to adjust airflow passing to the turbine wheel 22. The guide apparatus 28 may include an upper vane ring 30 axially offset from a lower vane ring 32 such that a plurality of spacers 34 and a plurality of vanes 36 may be arranged between the upper vane ring 30 and the lower vane ring 32. While secured in the turbine housing 14, the upper vane ring 30 may be disposed proximate the bearing housing 16.

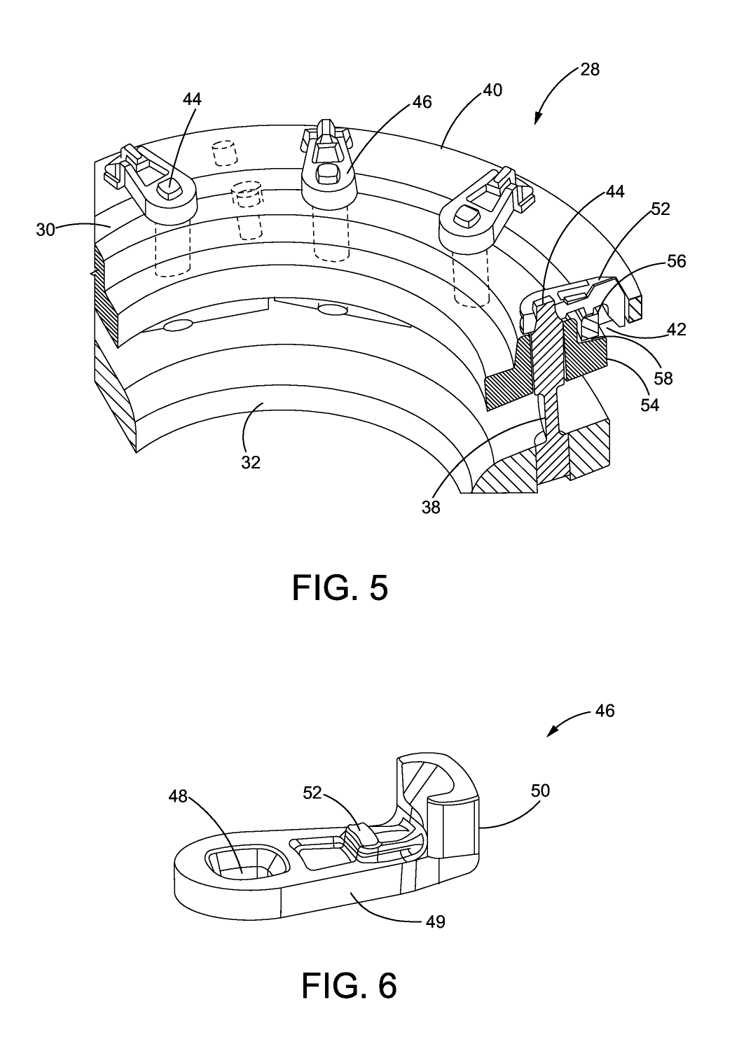

Referring to FIGS. 4 and 5, each vane of the plurality of vanes 36 may have an airfoil shape and may be mounted to a vane post 38 pivotally coupled to both the upper vane ring 30 and the lower vane ring 32. The guide apparatus 28 may also include an adjustment ring 40 arranged proximate the upper vane ring 30 such that the outer circumference of the adjustment ring 40 may be arranged radially outward of the upper vane ring 30. The adjustment ring 40 may be in mechanical association with the plurality of vanes 36 such that rotary motion of the adjustment ring 40, with respect to the upper vane ring 30, provides simultaneous pivotal movement to each vane of the plurality of vanes 36, as explained in more detail below. The adjustment ring 40 may include a plurality of apertures 42 arranged with each aperture circumferentially spaced apart from each other.

With particular reference to FIG. 5, each vane post 38 may penetrate the upper vane ring 30 exposing the head 44 of each vane post 38 such that the head 44 projects past the upper vane ring 30 in the axial direction. The guide apparatus 28 may include a plurality of vane levers 46 such that the head 44 of each vane post 38 may be coupled to a corresponding vane lever of the plurality of vane levers 46. For example, each vane lever of the plurality of vane levers 46 may include a bore 48, disposed through the base 49 of each vane lever 46, for receiving the head 44 of a corresponding vane post 38. The head 44 of the corresponding vane post 38 may be arranged in the bore 48 and riveted or welded to the vane lever 46 or secured thereto by any other manner well known in the industry.

As illustrated in FIG. 6, each vane lever of the plurality of vane levers 46 may include an arm 50 extending outwardly from the base 49. In an embodiment, the arm 50 may be disposed on the opposite end of the base 49 from the bore 48. A protuberance 52 or stop may be disposed on the base 49 of each vane lever of the plurality of vane levers 46. The protuberance 52 may outwardly extend in the same direction as the arm 50. In an embodiment, the protuberance 52 may be disposed, between the arm 50 and the bore 48, on each vane lever of the plurality of vane levers 46. It should be understood, however, that the protuberance 52 may be disposed in other locations on each vane lever of the plurality of vane levers 46.

Referring back to FIG. 5, each aperture of the plurality of apertures 42 of the adjustment ring 40 may receive an arm 50 of a corresponding vane lever of the plurality of vane levers 46 in such a manner that the protuberance 52 faces the adjustment ring 40 and the adjustment ring 40 is arranged axially between the plurality of vane levers 46 and a shoulder 54 of the upper vane ring 30. The shoulder 54 extends radially outward from the upper vane ring 30. Each arm 50 of the plurality of vane levers 46 may be received in corresponding apertures of the plurality of apertures 42 to collectively limit radial movement of the adjustment ring 40.

The guide apparatus 28 may include a lever clearance 56 between the adjustment ring 40 and each protuberance 52 of the plurality of vane levers 46 and may include a ring clearance 58 between the adjustment ring 40 and the shoulder 54 of the upper vane ring 30. While the lever clearance 56 and the ring clearance 58 may allow for minor axial movement of the adjustment ring 40 between the shoulder 54 of the upper vane ring 30 and the plurality of vane levers 46, the protuberance 52 on each vane lever of the plurality of vane levers 46 serves as an axial stop against the adjustment ring 40.

Referring back to FIG. 4, as both the upper vane ring 30 and the lower vane ring 32 may be secured to the turbine housing 14, the adjustment ring 40 may be actuated to rotate, with respect to the upper vane ring 30, in one direction or the other, as illustrated by a first double arrow 60, causing each vane lever of the plurality of vane levers 46 to also rotate in the one direction or the other, respectively, as illustrated by a second double arrow 62, which in turn rotates each vane post 38 thereby causing each corresponding vane of the plurality of vanes 36 to pivot between an open position and a closed position, respectively, as illustrated by a third double arrow 64. In such an arrangement, the unison pivoting of each vane of the plurality of vanes 36, via actuation of the adjustment ring 40, may regulate the air flowing to the turbine wheel 22. Moreover, while serving as an axial stop against the adjustment ring 40, the protuberance 52 also rotates in unison along with the adjustment ring 40 during operational rotation thereof, which may translate to less wear between the components.

While each vane lever of the plurality of vane levers 46 is described to include a protuberance 52, in alternative embodiments, a single one of the vane levers 46 may include the protuberance 52, alternating vane levers 46 may include the protuberance 52, or any other combination of vane levers 46 may include the protuberance 52.

### INDUSTRIAL APPLICABILITY

Based on the foregoing, it can be seen that the present disclosure can find applicability in many industries such as but not limited to those employing an internal combustion engine in various turbo machines such as, but not limited to, automobiles, trucks, aircraft, locomotives, ships, and auxiliary power generators. Through the novel teachings set forth above, the guide apparatus 28 may provide a protuberance 52 on at least one vane lever of the plurality of vane levers 46 to limit axial movement of the adjustment ring 40 such that the protuberance 52 and the adjustment ring 40 may rotate in unison with each other. In this manner, because the protuberance 52 rotates along with the adjustment ring 40, minimal sliding and rotational relative motion is present therebetween, which may be an advantage over other designs employing stationary axial stops that may cause wear due to the adjustment ring operationally rotating against the stationary axial stops. Moreover, the present disclosure may eliminate press fit manufacturing variations, which may be found in other designs. Furthermore, through the novel teachings set forth above, each vane lever of the plurality of vane levers 46 may be integrally manufactured with a protuberance 52 by any process well known in the industry such as, but not limited to, metal injection molding, casting, stamping, and fine blanking, thereby realizing a reduction of overall parts in the guide apparatus 28, and in turn, a reduction in costs.

In operation of the turbocharger 10, the plurality of vanes 36 of the guide apparatus 28 may be selectively adjusted to change the airflow passing to the turbine wheel 22 of the turbocharger 10. The plurality of vanes 36 may be adjusted, between an open position and a closed position, via selective actuation of the adjustment ring 40. For example, the adjustment ring 40 may be actuated to rotate, with respect to the upper vane ring 30, and, in turn, engage the plurality of vane levers 46 to also rotate thereby transmitting simultaneous pivotal movement to each vane of the plurality of vanes 36.

During operation of the turbocharger 10, the adjustment ring 40 may experience minor axial movement, which, however, may be limited as a result of the adjustment ring 40 abutting against the protuberance 50 of each vane lever of the plurality of vane levers 46. As such, the protuberance 50 of each vane lever of the plurality of vane levers 46 may serve as an axial stop to limit the axial movement of the adjustment ring 40. Moreover, because the protuberance 50 of each vane lever of the plurality of vane levers 46 rotates along with the adjustment ring 40, the relative motion, and in turn the amount of wear, therebetween may be minimal.

What is claimed is:

1. A guide apparatus (28) for a turbocharger (10), the guide apparatus (28) comprising:
an upper vane ring (30);
a lower vane ring (32) offset axially from the upper vane ring (30);
a plurality of vanes (36) disposed between and pivotally coupled to the upper vane ring (30) and the lower vane ring (32);
an adjustment ring (40) including a plurality of apertures (42), the adjustment ring (40) in mechanical association with the plurality of vanes (36); and
a plurality of vane levers (46) coupled to the plurality of vanes (36), the plurality of vane levers (46) received correspondingly by the plurality of apertures (42), each vane lever (46) of the plurality of vane levers (46) including a protuberance (52) facing the adjustment ring (40), the protuberance (52) capable of limiting axial movement of the adjustment ring (40).

2. The guide apparatus (28) of claim 1, wherein each vane lever (46) of the plurality of vane levers (46) includes an arm (50) extending in the same direction as the protuberance (52).

3. The guide apparatus (28) of claim 2, wherein each vane lever (46) of the plurality of vane levers (46) further includes a bore (48) disposed on an opposite end from the arm (50).

4. The guide apparatus (28) of claim 3, wherein the protuberance (52) is disposed between the bore (48) and the arm (50).

5. The guide apparatus (28) of claim 4, wherein each aperture (42) of the plurality of apertures (42) receives the arm (50) of one of the vane levers (46) of the plurality of vane levers (46).

6. The guide apparatus (28) of claim 5, wherein each vane (36) of the plurality of vanes (36) is mounted to a vane post (38), the vane post (38) pivotally coupled to the upper vane ring (30) and the lower vane ring (32).

7. A turbocharger (10), comprising:
a turbine housing (14);
a bearing housing (16) disposed between the turbine housing (14) and a compressor housing (12);
an upper vane ring (30) secured in the turbine housing (14) and proximate to the bearing housing (16);
a lower vane ring (32) offset axially from the upper vane ring (30);
a plurality of vanes (36) disposed between and pivotally coupled to the upper vane ring (30) and the lower vane ring (32);
an adjustment ring (40) in mechanical association with the plurality of vanes (36); and
a vane lever (46) coupled to one vane (36) of the plurality of vanes (36), the vane lever (46) including an arm (50) in mechanical association with the adjustment ring (40), the vane lever (46) including a protuberance (52) facing the adjustment ring (40), the protuberance (52) contactable with the adjustment ring (40) to limit axial movement thereof.

8. The turbocharger (10) of claim 7, further including a plurality of vane posts (38), each vane (36) of the plurality of vanes (36) mounted to a corresponding vane post (38) of the plurality of vane post (38).

9. The turbocharger (10) of claim 8, wherein the vane lever (46) is coupled to one vane post (38) of the plurality of vane posts (38).

10. The turbocharger (10) of claim 7, wherein the arm (50) is received by an aperture (42) disposed on the adjustment ring (40).

11. The turbocharger (10) of claim 7, wherein the upper vane ring (30) includes a shoulder (54) extending radially outward therefrom.

12. The turbocharger (10) of claim 11, wherein the adjustment ring (40) is arranged axially between the vane lever (46) and the shoulder (54) of the upper vane ring (30).

13. The turbocharger (10) of claim 7, wherein the vane lever (46) further includes a bore (48) disposed on an opposite end from the arm (50), the protuberance (52) disposed between the bore (48) and the arm (50).

14. A vane lever (46) for a guide apparatus (28) of a turbocharger (10), the vane lever (46) comprising:
a base (49) including a bore (48) disposed therethrough;
an arm (50) extending from the base (49), the arm (50) receivable in an aperture (42) of an adjustment ring (40) of the guide apparatus (28); and
a protuberance (52) extending from the base (49), the protuberance (52) capable of limiting axial movement of the adjustment ring (40).

15. The vane lever (46) of claim 14, wherein the arm (50) extends from the base (49) on an opposite end from the bore (48), and the protuberance (52) is disposed on the base (49) between the arm (50) and the bore (48).
